(19) United States
(12) Patent Application Publication
(10) Pub. No.: US 2025/0136006 A1
(43) Pub. Date: May 1, 2025

(54) TRUCK BED COVER ASSEMBLIES WITH SLIDING HINGE PANELS

(71) Applicant: Dee Zee, Inc., Des Moines, IA (US)

(72) Inventors: Bart Zylstra, Pleasant Hill, IA (US); Joshua Knichel, Altoona, IA (US); Eric Schuling, Bondurant, IA (US)

(73) Assignee: Dee Zee, Inc., Des Moines, IA (US)

(21) Appl. No.: 18/927,418

(22) Filed: Oct. 25, 2024

Related U.S. Application Data
(60) Provisional application No. 63/546,080, filed on Oct. 27, 2023.

(51) Int. Cl. B60R 9/04; B60J 7/16

(52) U.S. Cl. CPC B60R 9/04; B60J 7/1621

(57) ABSTRACT

A sliding mount assembly for use with a truck bed cover that includes a first panel attached to a second panel at a pivot axis includes a first mounting bracket that is configured to mount to the first panel and a second mounting bracket that is configured to mount to the second panel. A sliding rail is configured to connect to the first mounting bracket and the second mounting bracket such that the sliding rail spans the pivot axis between the first panel and the second panel. The sliding rail includes a track that extends in a vehicle longitudinal direction that is configured to slidably receive a sliding flange of the second mounting bracket such that the sliding flange slides within the track as the second panel is pivoted relative to the first panel to a raised position.

### CROSS-REFERENCE

This application claims the benefit of and priority to U.S. Provisional Patent Application No. 63/546,080, entitled “Truck Bed Cover Assemblies with Sliding Hinge Panels,” filed Oct. 27, 2023, the details of which are incorporated by reference.

### TECHNICAL FIELD

The present specification generally relates to truck bed covers and, more specifically, to truck bed cover assemblies that include sliding hinge panels.

### BACKGROUND

Some truck bed covers, sometimes referred to as tonneau covers, are made up of multiple interconnected panels that can be retracted or otherwise moved to provide access to the truck bed and extended to block access to the truck bed. With items carried above the truck bed, it may be difficult to retract the panels of the truck bed covers.

Accordingly, a need exists for alternative truck bed covers that can be opened in different situations.

### SUMMARY

In one embodiment, a sliding mount assembly for use with a truck bed cover that includes a first panel attached to a second panel at a pivot axis includes a first mounting bracket that is configured to mount to the first panel and a second mounting bracket that is configured to mount to the second panel. A sliding rail is configured to connect to the first mounting bracket and the second mounting bracket such that the sliding rail spans the pivot axis between the first panel and the second panel. The sliding rail includes a track that extends in a vehicle longitudinal direction that is configured to slidably receive a sliding flange of the second mounting bracket such that the sliding flange slides within the track as the second panel is pivoted relative to the first panel to a raised position.

In another embodiment, a truck bed cover assembly includes a first panel configured to fixedly attach to a truck bed and a second panel connected to the first panel; a hinge that connects the second panel to the first panel forming a pivot axis. A sliding mount assembly includes a first mounting bracket mounted to the first panel and a second mounting bracket mounted to the second panel. A sliding rail is connected to the first mounting bracket and the second mounting bracket such that the sliding rail spans the pivot axis. The sliding rail includes a track that extends in a vehicle longitudinal direction that slidably receives a sliding flange of the second mounting bracket such that the sliding flange slides within the track as the second panel is pivoted relative to the first panel to a raised position.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a diagrammatic side view of a truck bed cover assembly in a closed configuration including first and second panels and a vehicle accessory mounted across both the first and second panels, according to one or more embodiments shown and described herein;

FIG. 2 is a diagrammatic side view of the truck bed cover assembly of FIG. 1 in an open configuration with the second panel raised to a raised position and the first panel remaining fixed, according to one or more embodiments shown and described herein;

FIG. 3 is a perspective view of the truck bed cover assembly of FIG. 1 in the closed configuration with a vehicle accessory, according to one or more embodiments shown and described herein;

FIG. 4 is a perspective view of the truck bed cover assembly of FIG. 1 in the open configuration, according to one or more embodiments shown and described herein;

FIG. 5 is a side view of the truck bed cover assembly in isolation and with the second panel in a lowered position, according to one or more embodiments shown and described herein;

FIG. 6 is a side view of the truck bed cover assembly of FIG. 5 in isolation and with the second panel in a raised position, according to one or more embodiments shown and described herein;

FIG. 7 is a bottom prospective side view of a sliding rail for use with the truck bed cover assembly of FIG. 5, according to one or more embodiments shown and described herein;

FIG. 8 is a bottom perspective end view of the sliding rail of FIG. 5, according to one or more embodiments shown and described herein; and

FIG. 9 is an exploded view of an end portion of the sliding rail of FIG. 5, according to one or more embodiments shown and described herein.

### DETAILED DESCRIPTION

The present disclosure is generally directed to a truck bed cover assembly that allows for opening of a cover panel with a vehicle accessory mounted across a hinge location between multiple cover panels. The truck bed cover assembly includes a first panel that is configured to fixedly attach to a truck bed and a second panel connected to the first panel by a hinge such that the second panel can rotate between raised and lowered positions relative to the first panel. A sliding mount assembly includes a first exterior mount that is configured to mount to a first exterior side of the first panel and a second exterior mount that is configured to mount to a second exterior side of the second panel. A first mounting bracket is configured to mount to the first exterior mount and a second mounting bracket is configured to mount to the second exterior mount. A sliding rail is configured to connect to the first mounting bracket and the second mounting bracket such that the sliding rail spans the pivot axis between the first panel and the second panel. The sliding rail includes a track that extends in a vehicle longitudinal direction that is configured to slidably receive a flange of the second mounting bracket such that the flange slides within the track as the second panel is pivoted relative to the first panel to a raised position.

A sliding hinge can connect the second panel to the first panel. The sliding hinge can include a first mounting arm connected to the first panel and a second mounting arm connected to the second panel. The second mounting arm includes a first part rotatably connected to the first mounting arm at a pivot location and a second part connected to the second panel and configured to slide relative to the first part thereby moving the sliding hinge from a retracted configuration to an extended configuration as the second panel is moved from the lowered position to the raised position.

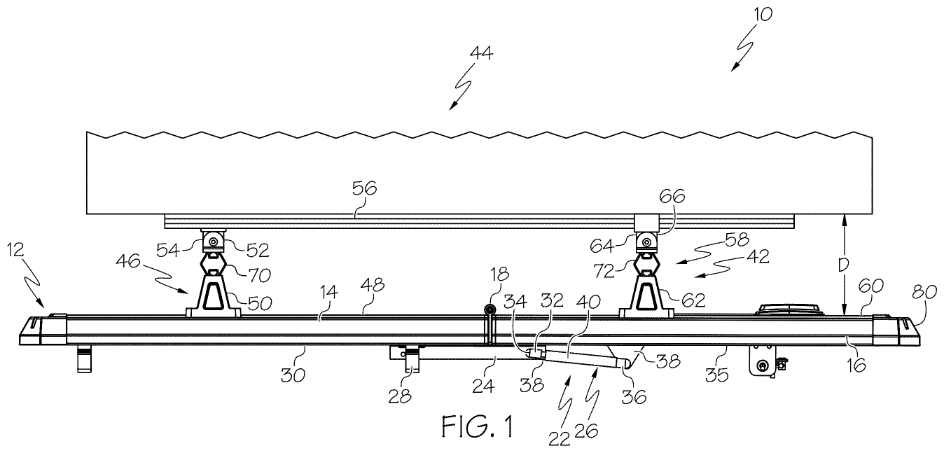

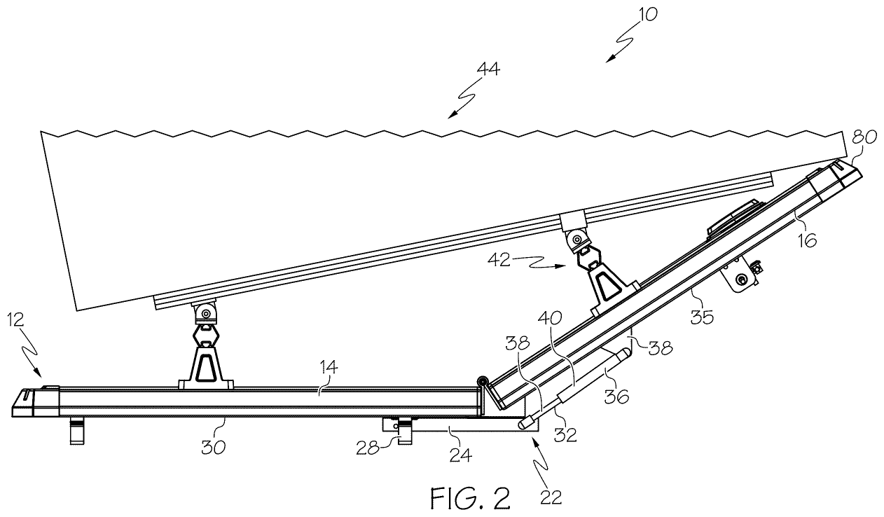

Referring to FIGS. 1 and 2, a truck bed cover assembly 10 includes a cover body 12 that includes a first panel 14 and a second panel 16. The second panel 16 is connected to the first panel 14 by a hinge 18 forming a pivot axis such that the second panel 16 can rotate between a lowered position (FIG. 1) and a raised position (FIG. 2) relative to the first panel 14. The hinge 18 is located at an exterior side 20 of the first and second panels 14 and 16.

A sliding hinge 22 is mounted to the first and second panels 14 and 16. In particular, the sliding hinge 22 includes a first mounting arm 24 that is mounted to the first panel 14 and a second mounting arm 26 that is mounted to the second panel 16. In some embodiments, the first mounting arm 24 has a fixed length and is fixed mounted to the first panel 14 using a mounting bracket 28 located at an interior side 30 of the first panel 14. The second mounting arm 26 includes a first part 32 that is rotatably connected to the first mounting arm 14 at a pivot location 34 and a second part 36 that is pivotally connected to the second panel 16 at an interior side 35 using mounting bracket 38 and is configured to slide in a vehicle longitudinal direction relative to the first part 32 thereby moving the sliding hinge 22 from a retracted configuration (FIG. 1) to an extended configuration (FIG. 2) as the second panel 16 is moved from the lowed position to the raised position. It should be noted that while the second mounting arm 26 is illustrated as having the first and second mounting arms 24 and 26, the length of the second mounting arm 26 may be fixed and the first mounting arm 24 may have the first and second mounting arms.

In some embodiments, the sliding hinge 22 may be in the form of an air cylinder that includes a piston rod 38 that is slidably received within an air cylinder 40. In some embodiments, the piston rod 38 telescopes in and out of the air cylinder 40, thereby increasing and decreasing an overall length of the sliding hinge 22. The air cylinder 40 may provide an air spring that uses compressed air to control opening and closing speeds of the second panel 16 relative to the first panel 14. For example, the air cylinder 40 may have compressed air that aids in lifting and opening the second panel 16.

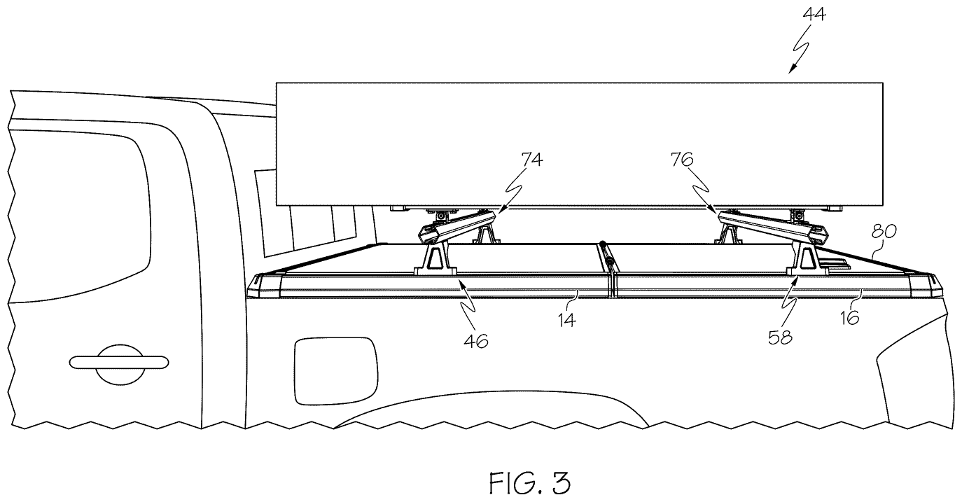

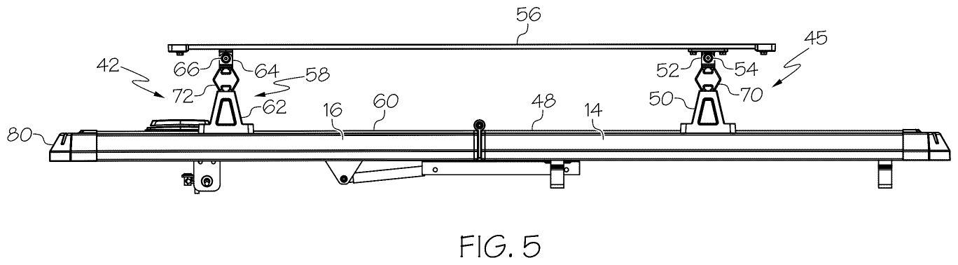

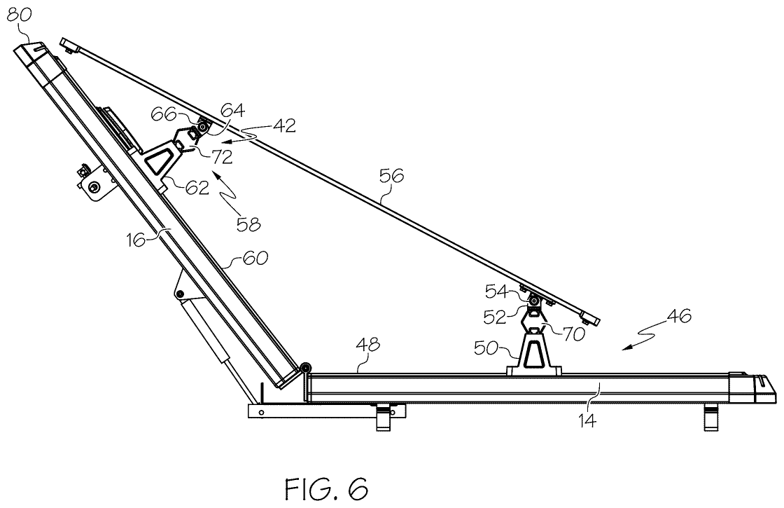

The truck bed cover assembly 10 may include a sliding mount assembly 42 that can be used to mount a vehicle accessory 44. The sliding mount assembly 42 may include a first exterior mount assembly 46 mounted to an exterior side 48 of the first panel 14. The first exterior mount assembly 46 may include a first exterior mount 50 that is configured to mount to the first panel 14 and a first mounting bracket 52 that includes a corresponding first mounting base 54 that is mounted to a sliding rail 56 of the sliding mount assembly 42 to which the vehicle accessory is mounted upon. The mounting system 42 may further include a second exterior mount assembly 58 mounted to an exterior side 60 of the second panel 16. The second exterior mount assembly 58 may include a second exterior mount 62 that is configured to mount to the second panel 16 and a second mounting bracket 64 that includes a corresponding second mounting base 66 that is mounted to the sliding rail 56 of the sliding mount assembly 42. In the illustrated example, the second mounting bracket 64 comprises the second mounting base 66 that is configured to rotate relative to the second exterior mount 62 as the second panel 16 is moved from the lowered position (FIGS. 1 and 5) to the raised position (FIGS. 2 and 6). In some embodiments, the first and second mounting brackets 52 and 64 may be mounted to respective cross rails 70 and 72 that are mounted to the first and second exterior mounts 50 and 62. In this regard, the first mounting bracket 52 is mounted to the first panel 14 and the second mounting bracket 64 is mounted to the second panel 16 through the respective cross rails 70 and 72 and first and second exterior mounts 50 and 62. In some embodiments, for example, there may be four exterior mount assemblies 46, 58, 74 and 76 as shown in FIG. 3.

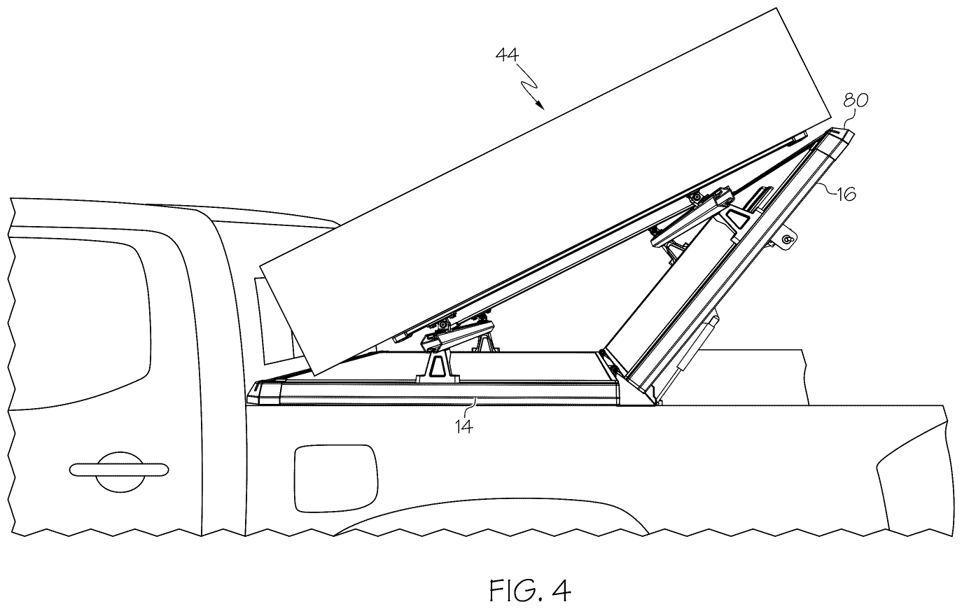

As can be seen in FIGS. 1-6, as the second panel 16 is moved to the raised position, a rear edge 80 of the second panel 16 moves closer toward the vehicle accessory sliding rail 56, reducing a vertical distance D (FIG. 1) between the sliding rail 56 and the rear edge 80. The sliding rail 56 may tilt upward along with the second panel 16 in order to accommodate the raising of the second panel 16.

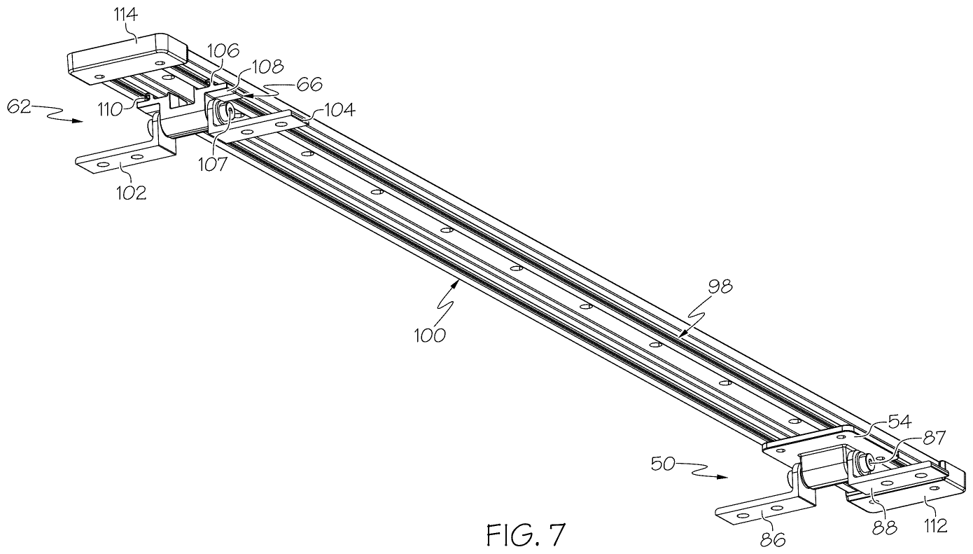

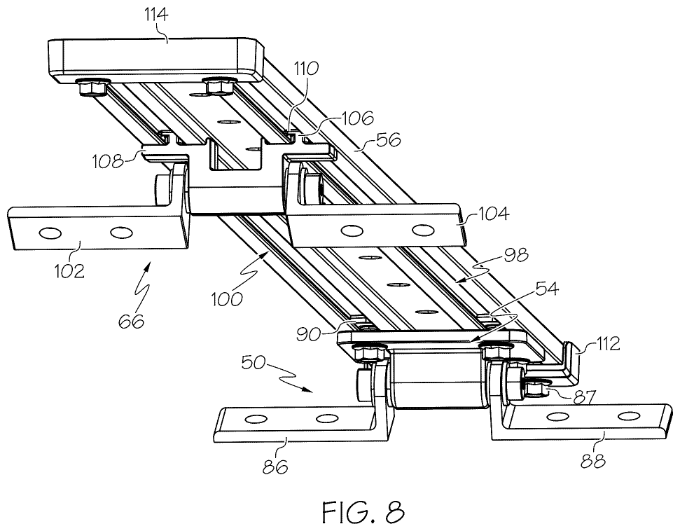

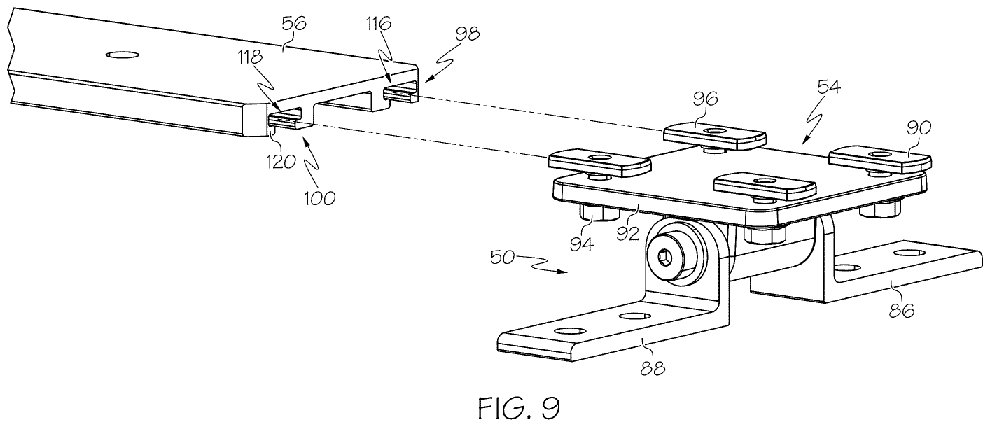

Referring to FIGS. 7 and 8, the first mounting bracket 52 includes angle brackets 86 and 88 that are pivotally connected to the first mounting base 54 at pivot location 87. Referring also to FIG. 9, the first mounting base 54 includes first sliding flanges 90 that are connected to a plate 92 of the first mounting base 54. In the illustrated example, the first sliding flanges 90 may be mounted to the plate 92 using fasteners 94. In some embodiments, at least some of the first sliding flanges 90 may be formed as a monolithic part of the plate 92, such as by casting, extruding, 3-D printing, etc. The first sliding flanges 90 each include an enlarged head 96 that is sized to be received within tracks 98 and 100 of the sliding rail 56. The tracks 82 and 84 extend in a vehicle longitudinal direction (i.e., in the front to back direction of the vehicle) along an elongated length of the sliding rail 56. While two tracks 98 and 100 are shown, there may be any number of suitable tracks, such as one track or more than two tracks.

Referring again to FIGS. 7 and 8, the second mounting bracket 64 includes angle brackets 102 and 104 that are pivotally connected to the second mounting base 66 at pivot location 107. The second mounting base 66 includes second sliding flanges 106 that are connected to a plate 108 of the second mounting base 66. In the illustrated example, the second sliding flanges 106 are formed as a monolithic part of the plate 108, such as by casting, extruding, 3-D printing, etc. In some embodiments, at least some of the second sliding flanges 106 may be formed separately from the plate and connected thereto, such as using fasteners, welding, etc. The second sliding flanges 106 each include an enlarged head 110 that is sized to be received within tracks 98 and 100 of the sliding rail 56.

Referring to FIG. 9, to illustrate, end covers 112 and 114 (FIGS. 7 and 8) of the sliding rail 56 can be removed to expose open ends 116 and 118 of tracks 98 and 100. Referring particularly to FIG. 9, the first sliding flanges 90 can be slidably received within the tracks 98 and 100 through the open ends 116 and 118. The tracks 98 and 100 may be T-shaped, having a necked down bottom portion 120 to retain the first sliding flanges 90 therein. When the first sliding flanges 90 are located within the tracks 90 and 100, the end cover 112 may be replaced and the process can be repeated with the second mounting base 66. In some embodiments, the fasteners 94 may be tightened once the second mounting bracket 64 is in place to fix the position of the second mounting bracket 64 along a length of the sliding rail 56.

Referring again to FIGS. 5 and 6, as the second panel 16 is raised, the second sliding flanges 106 of the second exterior mount 62 slide within the tracks 90 and 100 as a linear distance between the second exterior mount 62 and the first exterior mount 50 decreases. Such sliding by the second exterior mount 62 relative to the sliding rail 56 allows the second panel 16 to be raised without raising the first panel 14, which can provide the ability to at least partially raise a panel of a truck bed cover with a vehicle accessory mounted across multiple panels. One of the panels can remain fixed, while the other of the panels can rotate relative to the fixed panel. The accessory does not need to be removed in order to raise the rotatable panel hingedly connected to the fixed panel. The mounting system can be made universal to allow for different accessories to be attached to the mounting system, including but not limited to tents, platform racks, bike mounts, etc. Further, the mounting system can be used with various truck bed covers made from different manufacturers. As an example, the mounting system can be provided as a kit that is installed on a truck bed cover. The second exterior mount 62 can be restrained from sliding using any suitable device, such as a zip tie that can be removed during installation.

Embodiments can be described with reference to the following numbered clauses, with preferred features laid out in the dependent clauses:

Clause 1: A sliding mount assembly for use with a truck bed cover that includes a first panel attached to a second panel at a pivot axis, the sliding mount assembly comprising: a first mounting bracket that is configured to mount to the first panel; a second mounting bracket that is configured to mount to the second panel; and a sliding rail that is configured to connect to the first mounting bracket and the second mounting bracket such that the sliding rail spans the pivot axis between the first panel and the second panel, the sliding rail comprising a track that extends in a vehicle longitudinal direction that is configured to slidably receive a sliding flange of the second mounting bracket such that the sliding flange slides within the track as the second panel is pivoted relative to the first panel to a raised position.

Clause 2: The sliding mount assembly of clause 1, wherein the second mounting bracket comprises a mounting base comprising the sliding flange including an enlarged head that is sized to be received within the track.

Clause 3: The sliding mount assembly of clause 1 or 2, wherein the track is a first track and the sliding flange is a first sliding flange, the sliding rail comprising a second track that extends in the vehicle longitudinal direction that is configured to slidably receive a second sliding flange of the second mounting bracket such that the second sliding flange slides within the track as the second panel is pivoted relative to the first panel to the raised position.

Clause 4: The sliding mount assembly of any of clauses 1-3, wherein the track is T-shaped having a necked-down portion configured to retain the sliding flange therein.

Clause 5: The sliding mount assembly of any of clauses 1-4, wherein the sliding rail comprises an end cover that is configured to be removed to expose an open end of the track.

Clause 6: The sliding mount assembly of any of clauses 1-5, wherein the sliding flange is a first sliding flange, the first mounting bracket comprising a second sliding flange that is configured to be received by the track.

Clause 7: The sliding mount assembly of clause 6, wherein the second sliding flange is fastened to a plate of the first mounting bracket.

Clause 8: The sliding mount assembly of any of clauses 1-7, wherein the second mounting bracket comprises a bracket and a mounting base that is pivotally mounted to the bracket, the mounting base comprising the sliding flange.

Clause 9: The sliding mount assembly of any of clauses 1-8, wherein the first mounting bracket comprises a bracket and a mounting base that is pivotally mounted to the bracket, the mounting base configured to be connected to the sliding rail.

Clause 10: The sliding mount assembly of any of clauses 1-9, wherein the sliding flange is formed monolithically with a plate of the second mounting bracket.

Clause 11: A truck bed cover assembly comprising: a first panel configured to fixedly attach to a truck bed; a second panel connected to the first panel; a hinge that connects the second panel to the first panel forming a pivot axis; a sliding mount assembly comprising: a first mounting bracket mounted to the first panel; a second mounting bracket mounted to the second panel; and a sliding rail that is connected to the first mounting bracket and the second mounting bracket such that the sliding rail spans the pivot axis, the sliding rail comprising a track that extends in a vehicle longitudinal direction that slidably receives a sliding flange of the second mounting bracket such that the sliding flange slides within the track as the second panel is pivoted relative to the first panel to a raised position.

Clause 12: The truck bed cover assembly of clause 11, wherein the second mounting bracket comprises a mounting base comprising the sliding flange including an enlarged head that is sized to be received within the track.

Clause 13: The truck bed cover assembly of clause 11 or 12, wherein the track is a first track and the sliding flange is a first sliding flange, the sliding rail comprising a second track that extends in the vehicle longitudinal direction that is configured to slidably receive a second sliding flange of the second mounting bracket such that the second sliding flange slides within the track as the second panel is pivoted relative to the first panel to the raised position.

Clause 14: The truck bed cover assembly of any of clauses 11-13, wherein the track is T-shaped having a necked-down portion configured to retain the sliding flange therein.

Clause 15: The truck bed cover assembly of any of clauses 11-14, wherein the sliding rail comprises an end cover that is configured to be removed to expose an open end of the track.

Clause 16: The truck bed cover assembly of any of clauses 11-15, wherein the sliding flange is a first sliding flange, the first mounting bracket comprising a second sliding flange that is configured to be received by the track.

Clause 17: The truck bed cover assembly of claim 16, wherein the second sliding flange is fastened to a plate of the first mounting bracket.

Clause 18: The truck bed cover assembly of any of clauses 11-17, wherein the second mounting bracket comprises a bracket and a mounting base that is pivotally mounted to the bracket, the mounting base comprising the sliding flange.

Clause 19: The truck bed cover assembly of any of clauses 11-18, wherein the first mounting bracket comprises a bracket and a mounting base that is pivotally mounted to the bracket, the mounting base configured to be connected to the sliding rail.

Clause 20: The truck bed cover assembly of any of clauses 11-19, wherein the sliding flange is formed monolithically with a plate of the second mounting bracket.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A sliding mount assembly for use with a truck bed cover that includes a first panel attached to a second panel at a pivot axis, the sliding mount assembly comprising:
a first mounting bracket that is configured to mount to the first panel;
a second mounting bracket that is configured to mount to the second panel; and
a sliding rail that is configured to connect to the first mounting bracket and the second mounting bracket such that the sliding rail spans the pivot axis between the first panel and the second panel, the sliding rail comprising a track that extends in a vehicle longitudinal direction that is configured to slidably receive a sliding flange of the second mounting bracket such that the sliding flange slides within the track as the second panel is pivoted relative to the first panel to a raised position.

2. The sliding mount assembly of claim 1, wherein the second mounting bracket comprises a mounting base comprising the sliding flange including an enlarged head that is sized to be received within the track.

3. The sliding mount assembly of claim 1, wherein the track is a first track and the sliding flange is a first sliding flange, the sliding rail comprising a second track that extends in the vehicle longitudinal direction that is configured to slidably receive a second sliding flange of the second mounting bracket such that the second sliding flange slides within the track as the second panel is pivoted relative to the first panel to the raised position.

4. The sliding mount assembly of claim 1, wherein the track is T-shaped having a necked-down portion configured to retain the sliding flange therein.

5. The sliding mount assembly of claim 1, wherein the sliding rail comprises an end cover that is configured to be removed to expose an open end of the track.

6. The sliding mount assembly of claim 1, wherein the sliding flange is a first sliding flange, the first mounting bracket comprising a second sliding flange that is configured to be received by the track.

7. The sliding mount assembly of claim 6, wherein the second sliding flange is fastened to a plate of the first mounting bracket.

8. The sliding mount assembly of claim 1, wherein the second mounting bracket comprises a bracket and a mounting base that is pivotally mounted to the bracket, the mounting base comprising the sliding flange.

9. The sliding mount assembly of claim 1, wherein the first mounting bracket comprises a bracket and a mounting base that is pivotally mounted to the bracket, the mounting base configured to be connected to the sliding rail.

10. The sliding mount assembly of claim 1, wherein the sliding flange is formed monolithically with a plate of the second mounting bracket.

11. A truck bed cover assembly comprising:
a first panel configured to fixedly attach to a truck bed;
a second panel connected to the first panel;
a hinge that connects the second panel to the first panel forming a pivot axis;
a sliding mount assembly comprising:
a first mounting bracket mounted to the first panel;
a second mounting bracket mounted to the second panel; and
a sliding rail that is connected to the first mounting bracket and the second mounting bracket such that the sliding rail spans the pivot axis, the sliding rail comprising a track that extends in a vehicle longitudinal direction that slidably receives a sliding flange of the second mounting bracket such that the sliding flange slides within the track as the second panel is pivoted relative to the first panel to a raised position.

12. The truck bed cover assembly of claim 11, wherein the second mounting bracket comprises a mounting base comprising the sliding flange including an enlarged head that is sized to be received within the track.

13. The truck bed cover assembly of claim 11, wherein the track is a first track and the sliding flange is a first sliding flange, the sliding rail comprising a second track that extends in the vehicle longitudinal direction that is configured to slidably receive a second sliding flange of the second mounting bracket such that the second sliding flange slides within the track as the second panel is pivoted relative to the first panel to the raised position.

14. The truck bed cover assembly of claim 11, wherein the track is T-shaped having a necked-down portion configured to retain the sliding flange therein.

15. The truck bed cover assembly of claim 11, wherein the sliding rail comprises an end cover that is configured to be removed to expose an open end of the track.

16. The truck bed cover assembly of claim 11, wherein the sliding flange is a first sliding flange, the first mounting bracket comprising a second sliding flange that is configured to be received by the track.

17. The truck bed cover assembly of claim 16, wherein the second sliding flange is fastened to a plate of the first mounting bracket.

18. The truck bed cover assembly of claim 11, wherein the second mounting bracket comprises a bracket and a mounting base that is pivotally mounted to the bracket, the mounting base comprising the sliding flange.

19. The truck bed cover assembly of claim 11, wherein the first mounting bracket comprises a bracket and a mounting base that is pivotally mounted to the bracket, the mounting base configured to be connected to the sliding rail.

20. The truck bed cover assembly of claim 11, wherein the sliding flange is formed monolithically with a plate of the second mounting bracket.
